(19) United States
(12) Patent Application Publication
(10) Pub. No.: US 2007/0024572 A1
(43) Pub. Date: Feb. 1, 2007

(54) DISPLAY APPARATUS AND METHOD OF CONTROLLING THE BACKLIGHT PROVIDED IN THE DISPLAY APPARATUS

(76) Inventor: Shigeki Kamimura, Tsurugashima-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/421,599

(22) Filed: Jun. 1, 2006

(30) Foreign Application Priority Data
Jul. 27, 2005 (JP) 2005-217776

(51) Int. Cl. G09G 3/36

(52) U.S. Cl. 345/102

(57) ABSTRACT

A display apparatus comprising a receiving unit, a signal-processing unit, and a display device. Histogram distribution data is generated for a luminance level of a video signal output from the signal-processing unit. The apparatus further has a first multiplier, a second multiplier, and a differentiator. The first multiplier multiplies the histogram distribution data by multiplying values, where the higher the luminance level of each part of the histogram data is. The multiplier multiplies the histogram distribution data by multiplying values, where the lower the luminance level of each part of the histogram data is. The differentiator finds a difference between outputs of the first and second multipliers, generating control data that lowers a luminance-adjusting voltage of the display device in accordance with the magnitude ratio of the output from the first multiplier to the output of the second multiplier.

### CROSS-REFERENCE TO RELATED APPLICATIONS

This application is based upon and claims the benefit of priority from Japanese Patent Application No. 2005-217776, filed Jul. 27, 2005, the entire contents of which are incorporated herein by reference.

### BACKGROUND

1. Field

One embodiment of the invention relates to a device and method for controlling the backlight provided in the display apparatus. More particularly, the embodiment of the invention relates to a display apparatus that can display high-quality images at low power consumption, and to a device and method for controlling the backlight provided in this display apparatus.

2. Description of the Related Art

As known in the art, digital television broadcasting has been promoted in recent years. In Japan, for example, not only satellite digital broadcasting systems, such as broadcasting-satellite (BS) digital broadcasting and 110-communications satellite (CS) digital broadcasting, but also the ground digital broadcasting has come into service.

Television broadcast receivers of a new type have come into use. They incorporate a record/playback device that automatically records any broadcast program that accords with the genre and keyword the user has input. When the user selects any broadcast program thus recorded, the record/playback device plays back the broadcast program.

The record/playback device includes a storage capacity large enough to record a number of broadcast programs. It also needs to access and retrieve any recorded program selected, as fast as possible. In view of this, a hard disk drive (HDD) is used as record/playback device.

The digital television broadcast receivers recently provided have a large display device and can be connected to various peripheral devices. In addition, they are connected, in increasing numbers, to networks. To improve the quality of images the display device may display, techniques have been developed, which adjust not only video signals, but also the amount of light the backlight emits.

To adjust the amount of light, the power-supply voltage of the backlight may be changed. When the power-supply voltage is changed, the image displayed may be degraded. Particularly in a large liquid crystal display, changes in the power-supply voltage of the backlight greatly influence the image gradation. Therefore, the power-supply voltage should be carefully controlled.

Jpn. Pat. Appln. KOAKI Publication Nos. 2004-110050 and 2005-148709 disclose the technique of controlling the voltage of a backlight in accordance with the characteristics of the video signals supplied to the display device that incorporates the backlight.

The technique disclosed in, for example, Jpn. Pat. Appln. KOAKI Publication No. 2004-110050 lies in using the average picture level (APL) and the measured histogram distribution. First, a luminance-level region, e.g., a dark region, is designated and measured. Then, it is determined whether the histogram distribution measured exceeds the threshold value for the luminance-level region designated. If the histogram distribution does, the region is regarded as a dark region, regardless of the APL determined.

The technique disclosed in, for example, Jpn. Pat. Appln. KOAKI Publication No. 2005-148709 resides in measuring the histogram distribution from a video signal. The most frequent value F, i.e., the gradation existing more frequently in one image frame than any other gradation, is obtained from the distribution. In the backlight control unit, a plurality of regions have been set for gradations 0 to 255, each defined by eight bits. Those of the regions, which are pertinent to the value F, are examined. The backlight control unit outputs the control data set for the regions pertinent to the value F. The control data controls the amount of light the backlight emits.

In the conventional techniques, the regions for which the histogram distribution measured is applied are limited to those that have specific luminance levels. Further, the average picture level and the histogram distribution measured are used in combination, to control the backlight. In the conventional image display devices, however, no measures are taken to reduce power consumption.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the front of a television broadcast receiver that is an embodiment of this invention;

FIG. 2 is an exemplary block diagram of the signal-processing system incorporated in the television broadcast receiver according to an embodiment of the invention;

FIG. 3 is an exemplary block diagram depicting the major components of the receiver, which are characterizing features of an embodiment of the invention;

FIG. 4 is an exemplary diagram showing a histogram distribution according to an embodiment of the invention;

FIG. 5A is an exemplary diagram explaining how the multiplier A as shown in FIG. 3 multiplies a histogram distribution by multiplying values A;

FIG. 5B is an exemplary diagram explaining how the multiplier B shown in FIG. 3 multiplies a histogram distribution by multiplying values B;

FIG. 6 is an exemplary diagram explaining how a histogram distribution is multiplied by multiplying values A and multiplying values B;

FIG. 7A is an exemplary diagram explaining how the multiplier A shown in FIG. 3 multiplies the histogram distribution by other multiplying values A;

FIG. 7B is an exemplary diagram explaining how the multiplier B shown in FIG. 3 multiplies the histogram distribution by other multiplying values B;

FIG. 8 is an exemplary flowchart showing how the television broadcast receiver shown in FIG. 1 operates; and

FIG. 9 is an exemplary block diagram depicting a television broadcast receiver that is another embodiment of this invention.

### DETAILED DESCRIPTION

Various embodiments according to the invention will be described hereinafter with reference to the accompanying drawings.

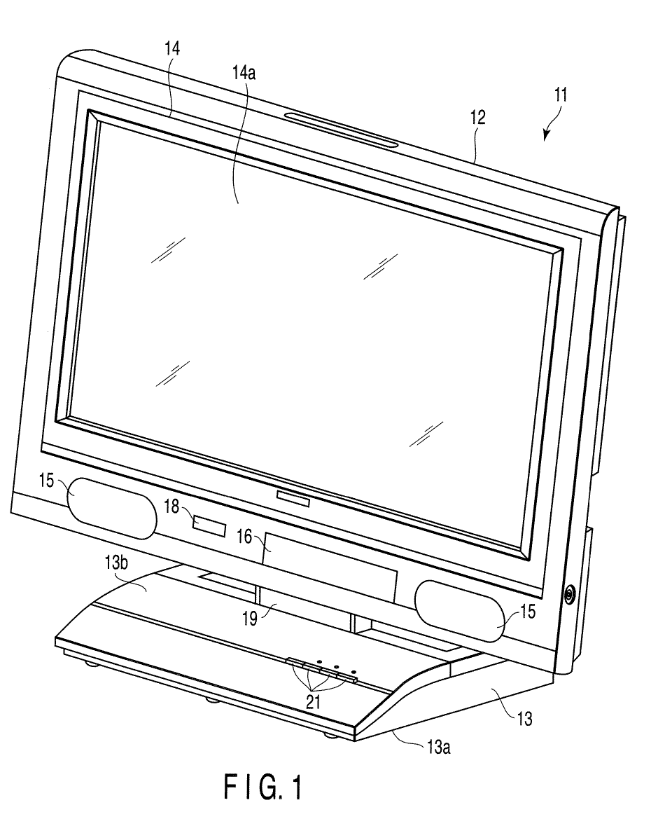

FIG. 1 is a perspective view showing the front of a television broadcast receiver 11 that is an embodiment of this invention. As FIG. 1 shows, the receiver 11 comprises a cabinet 12 and a stand 13. The cabinet 12 is the main unit of the receiver 11, which is thin and rectangular. The stand 13 supports and holds the cabinet 12 in standing position.

The display screen 14a of a display 14 is exposed at the front of the cabinet 12. The display 14 comprises, for example, a flat liquid crystal panel. A pair of speakers 15, an operation unit 16, and a light-receiving unit 18 are arranged on the front of the cabinet 12. The light-receiving unit 18 is configured to receive operation data from a remote controller 17 (not shown in FIG. 1).

The stand 13 is shaped like a thin box. It is configured to be mounted on a horizontal flat base (not shown), with its bottom plate 13a contacting the flat base. The stand 13 has a support member 19 that protrudes upward from the center part of the top plate 13b, which opposes the bottom plate 13a. The support member 19 is coupled to the back of the cabinet 12. The stand 13 therefore holds the cabinet 12 in the standing position.

The stand 13 incorporates an HDD unit 20 (not shown in FIG. 1). Buttons 21 (four buttons in this embodiment) are arranged on that part of the top plate 13b, which lies in front of the cabinet 12. The buttons 21 may be depressed to set the HDD unit 20 to various operating modes, such as recording mode, playback mode and stop mode.

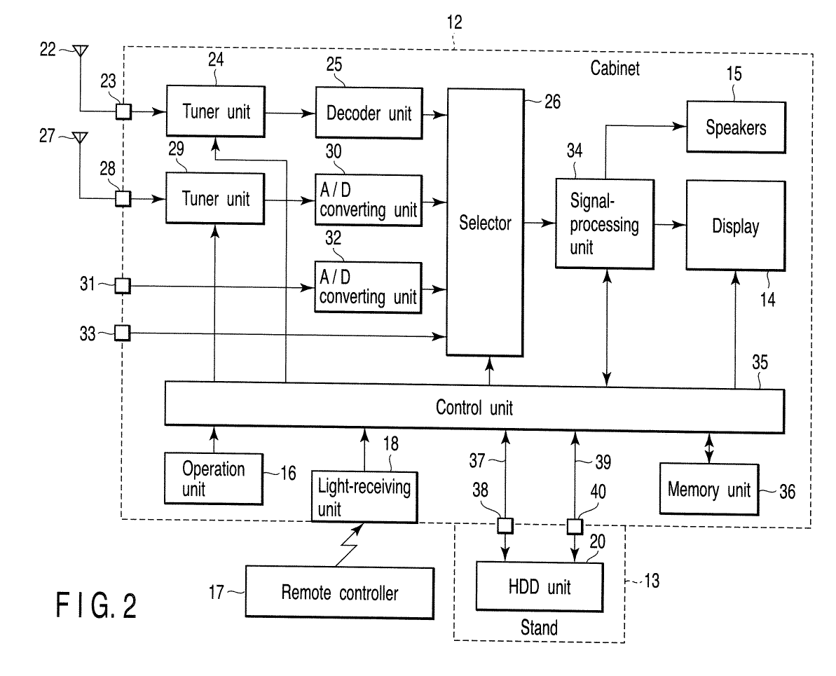

FIG. 2 schematically shows the signal-processing system incorporated in the television broadcast receiver 11. Most components of the signal-processing system are provided in the cabinet 12 and located near the back thereof. In other words, they are positioned at the back of the display screen 14a of the display 14.

An antenna 22 connected to the signal-processing system receives a digital television broadcast signal. The signal is supplied via an input terminal 23 to a tuner unit 24. The tuner unit 24 extracts a signal of a desired channel from the digital television broad signal input to it. The signal output from the tuner unit 24 is supplied to a decoder unit 25. The decoder unit 25 performs decoding, such as moving picture experts group 2 (MPEG2) decoding, on the signal input to it. The signal thus decoded is supplied to a selector 26.

The signal output from the tuner unit 24 is supplied directly to the selector 26. The selector 26 extracts video data and audio data from this signal. The video data and the audio data are supplied via a control unit 35 to the HDD unit 20. Thus, they can be recorded in the HDD unit 20.

Another antenna 27 is connected to the signal-processing system, too. This antenna 27 receives an analog television broadcast signal. This signal is supplied via an input terminal 28 to a tuner unit 29. This tuner unit 29 extracts a signal of the desired channel from the analog television broadcast signal and demodulates the same. The signal output from the tuner unit 29 is supplied to an analog/digital (A/D) converting unit 30. The A/D converting unit 30 converts the signal to a digital signal, which is output to the selector 26.

An analog video signal and an analog audio signal are supplied to an analog-signal input terminal 31 and thence to an A/D converting unit 32. The A/D converting unit 32 converts these signals to digital signals, which are supplied to the selector 26. Further, the analog video signal and the analogy audio signal are supplied to a digital-signal input terminal 33 and thence to the selector 26.

To record an A/D-converted signal in the HDD unit 20, the encoder incorporated in the selector 26 compresses the signal in a prescribed format such as MPEG2 format. Any A/D-converted signal, thus compressed, can be recorded in the HDD unit 20.

The selector 26 selects one of the four input digital video-audio signal, and supplies the selected video-audio signal to a signal-processing unit 34. The signal-processing unit 34 performs a specific process on the digital video signal contained in the video-audio signal. The digital video signal thus processed is supplied to the above-mentioned display 14. The image display 14 displays the image represented by the digital video signal. The display 14 is a flat panel display, such as a liquid crystal display or a plasma display. The signal-processing unit 34 performs a process on the digital audio signal contained in the video-audio signal, converting the signal to analog signals. The analog signals are supplied to the above-mentioned speakers 15, respectively. The speakers 15 generate sound from the analog signals, thus accomplishing audio playback.

In the television broadcast receiver 11, the control unit 35 controls various operations including the signal reception. The control unit 35 is a microprocessor that incorporates a central processing unit (CPU) and the like. The unit 35 receives the operation data generated when the operation unit 16 and buttons 21 are operated. The unit 35 also receives the operation data from a remote controller 17 through the light-receiving unit 18. In accordance with the operation data, the unit 35 controls some of the other components of the television broadcast receiver 11, in accordance with the operation data.

The control unit 35 uses a memory unit 36. The memory unit 36 comprises a read only memory (ROM), a random access memory (RAM), and a nonvolatile memory. The ROM stores the control programs the CPU executes. The RAM provides work areas for the CPU. The nonvolatile memory is provided to store various set data items, control data items and the like.

Note that the control unit 35 is connected to the HDD unit 20 that is provided in the stand 12. A line 37 is provided to supply power and control signals to the HDD unit 20. A connection unit 38 connects the line 37 to the control unit 35 and HDD unit 20.

A line 39 is provided, through which the control unit 35 and the HDD unit 20 exchange digital video and audio signals between them. An i-Link connection unit 40 connects the line 39 to the control unit 35 and the HDD unit 20. Hence, digital video signals and digital audio signals are transferred between the control unit 35 and the HDD unit 20 by an i-Link, independently of the power and the control signals.

Any digital video signal and any audio signal that the selector 26 has selected in the television broadcast receiver 11 can, therefore, be recorded in the HDD unit 20. Moreover, the television broadcast receiver 11 can playback the digital video signal and the digital audio signal. Thus, the user can enjoy seeing the images represented by the video signal and listening to the sound represented by the audio signal.

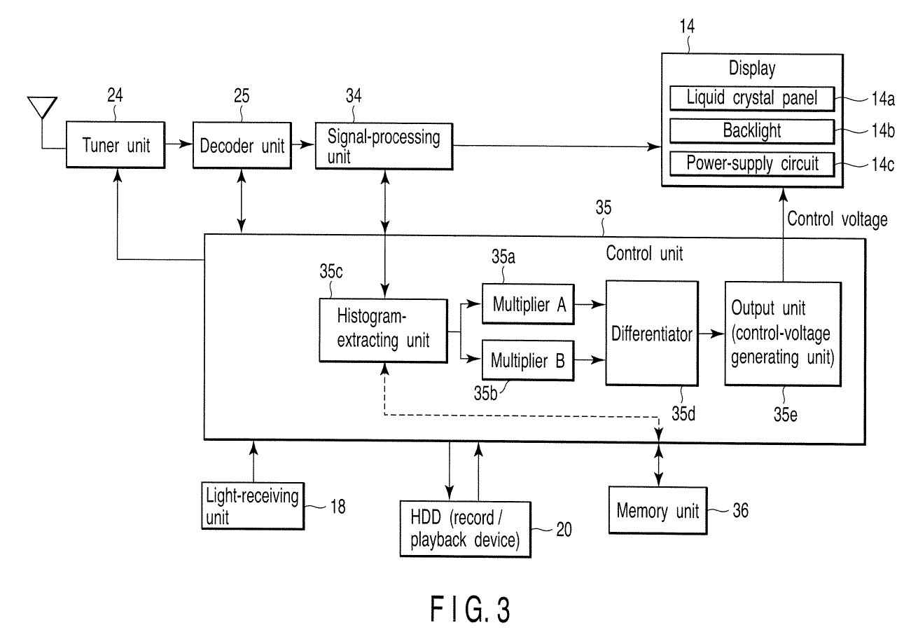

FIG. 3 shows the major components of the receive 11, which are characterizing features of this invention. The control unit 35 includes five components, i.e., two multipliers 35a and 35b, a histogram-extracting unit 35c, a differentiator 35d, and an output unit 35e.

The histogram-extracting unit 35c generates histogram distribution data about the luminance level of a video signal output from the signal-processing unit 34. The memory unit 36 temporarily stores a one-frame or one-field of the video signal output from the unit 34. From the one-frame or one-field of the video signal, the histogram-extracting unit 35c generates data representing the luminance-level histogram distribution.

The first multiplier 35a multiplies the luminance-level histogram distribution data supplied from the histogram-extracting unit 35c, by multiplying values, one after another. The higher the luminance level of each part of the histogram data is, the smaller the multiplying value applied thereto is. Thus, the first multiplier 35a obtains products, each pertaining to the distribution data and one multiplying value.

The second multiplier 35b multiplies the luminance-level histogram distribution data supplied from the histogram-extracting unit 35c, by multiplying values, one after another. The lower the luminance level of each part of the histogram data is, the smaller the multiplying value applied thereto is. Hence, the second multiplier 35b obtains products, each pertaining to the data and one multiplying values.

The differentiator 35 finds a difference between the outputs of the multipliers 35a and 35b. The differentiator 35d generates control data in accordance with the magnitude ratio of the output from the first multiplier 35a. The control data is input to the output unit 35e. The output unit 35e generates a control voltage from the control data. The control voltage is applied to the display 14.

The display 14 has a backlight 14b and a power-supply circuit 14c. The back light 14b is provided in the back of the liquid crystal panel 14a. The power-supply circuit 14c drives the backlight 14b. The control voltage (i.e., light-controlling voltage) generated by the output unit 35e of the control unit 35 is applied to the power-supply circuit 14c. The control voltage can adjust the luminance of the backlight 14b.

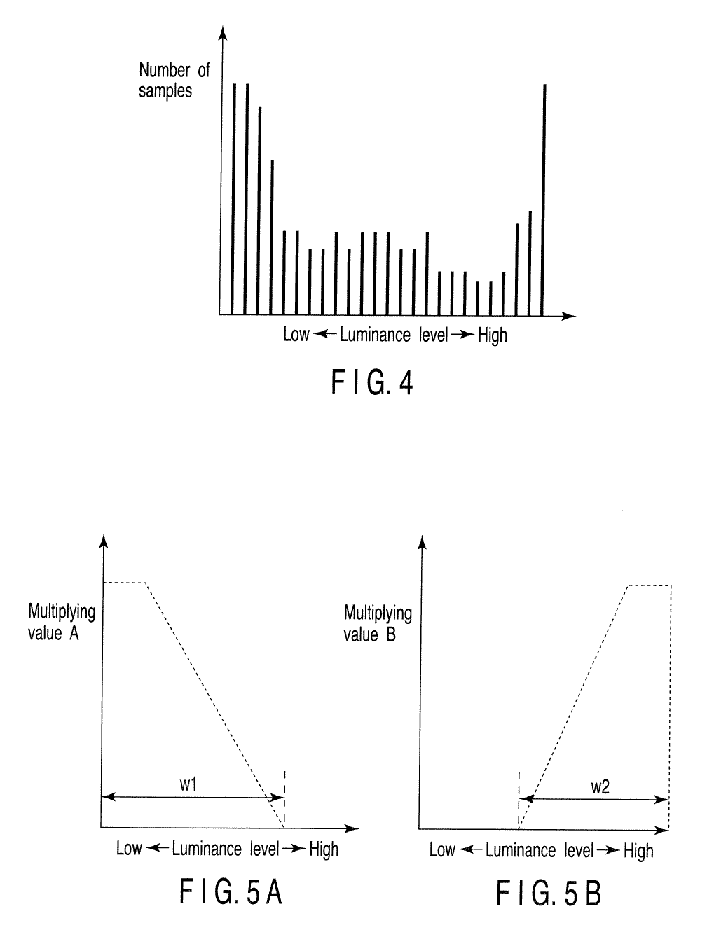

FIG. 4 represents a histogram distribution that the histogram-extracting unit 35c has generated. The multiplier 35a has such multiplying values A as shown in FIG. 5A. The multiplier 35b has such multiplying values B as shown in FIG. 5B. The multiplying values A and B may be stored in the memory unit 36. The multipliers 35a and 35b multiply histogram distribution data items for the same luminance level, by multiplying values A and multiplying values B, respectively. The products that the multipliers 35a and 35b generate, each being the product of one data item and one multiplying value, are accumulated (or multiplied by one another).

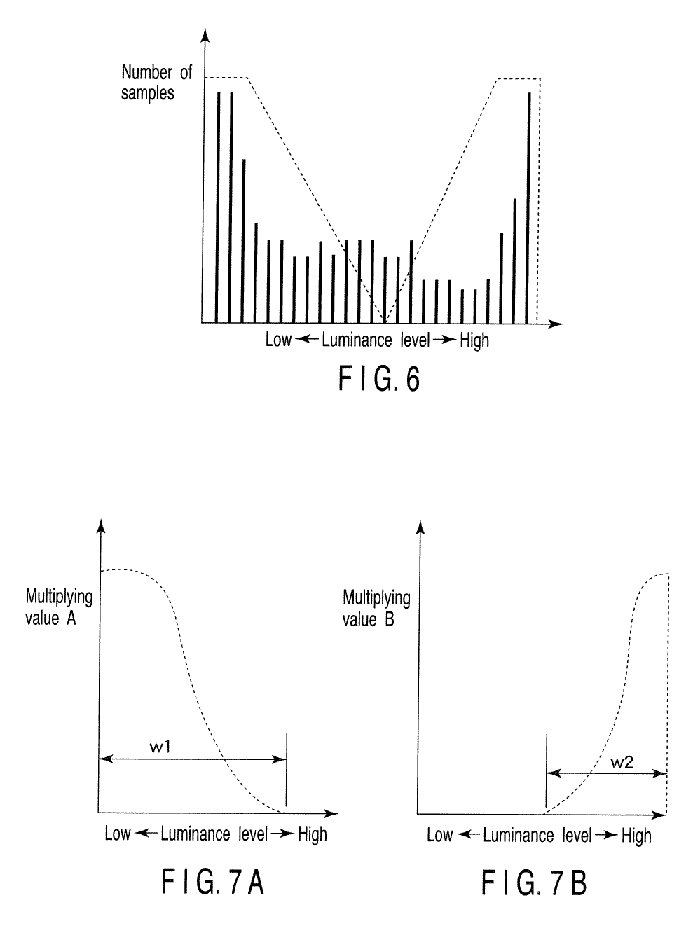

FIG. 6 schematically explains how the histogram distribution data is multiplied by multiplying values A (FIG. 5A) and multiplying values B (FIG. 5B). As seen from FIG. 6, two histogram distribution data items for the same luminance level are multiplied by multiplying values A and multiplying values B, respectively.

The range of luminance (W1) over which the multiplying values A of the first multiplier 35a are distributed is broader than the range of luminance (W2) over which the multiplying values B of the second multiplier 35b are distributed; namely, W1>W2. This is because the control unit 35 is designed to save more power for dark images than for bright images. In other words, the control unit 35 is designed on the idea that the backlight 14b need not emit so much light for dark images as for bright images.

As FIG. 5A shows, multiplying values A are linearly distributed. More precisely, the higher the luminance level of each part of the histogram data is, the smaller the multiplying value applied thereto is. As FIG. 5B shows, multiplying values B are linearly distributed. More specifically, the lower the luminance level of each part of the histogram data is, the smaller the multiplying value applied thereto is.

Nonetheless, the distribution of multiplying values A and B is not limited to the one illustrated in FIGS. 5A and 5B in this invention. Multiplying values A of the first multiplier 35a may be nonlinearly distributed as shown in FIG. 7A. In this case, the higher the luminance level of each part of the histogram data is, the smaller the multiplying value applied thereto is. Similarly, multiplying values B of the second multiplier 35b may be nonlinearly distributed as shown in FIG. 7B. In this case, the lower the luminance level of each part of the histogram data is, the smaller the multiplying value applied thereto is. Further, it is desired that range of luminance (W1) over which the multiplying values A of the first multiplier 35a are distributed be broader than that (W2) over which the multiplying values B of the second multiplier 35b are distributed; namely, W1>W2.

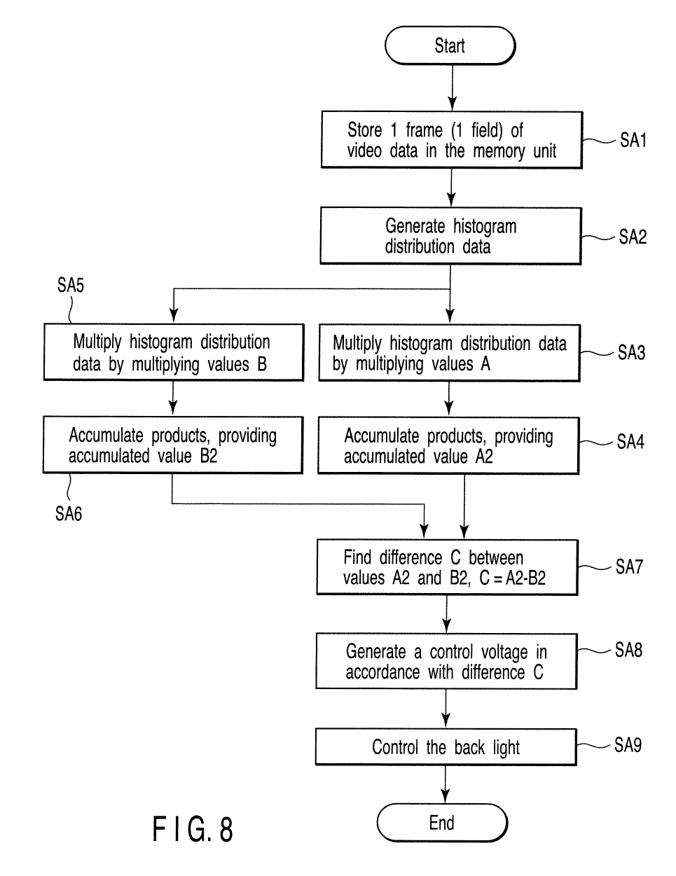

FIG. 8 is a flowchart showing how the television broadcast receiver 11 operates. The memory unit 36 stores one frame (or one field) of the video signal output from the signal-processing unit 34 (Block SA1). Histogram distribution data is generated (Block SA2). The histogram distribution data is then multiplied by multiplying values A (Block SA3). The histogram distribution data is multiplied by multiplying values B, too (Block SA5). The products generated in Block SA3 are accumulated (Block SA4), providing accumulated value A2. Similarly, the products generated in Block SA5 are accumulated (Block SA6), providing accumulated value B2.

Next, the accumulated value B2 is subtracted from the accumulated value A2, obtaining a difference C; C=A2−B2 (Block SA7). A control voltage is generated in accordance with the difference C (Block SA8). The control voltage controls the backlight 14b (Block SA9).

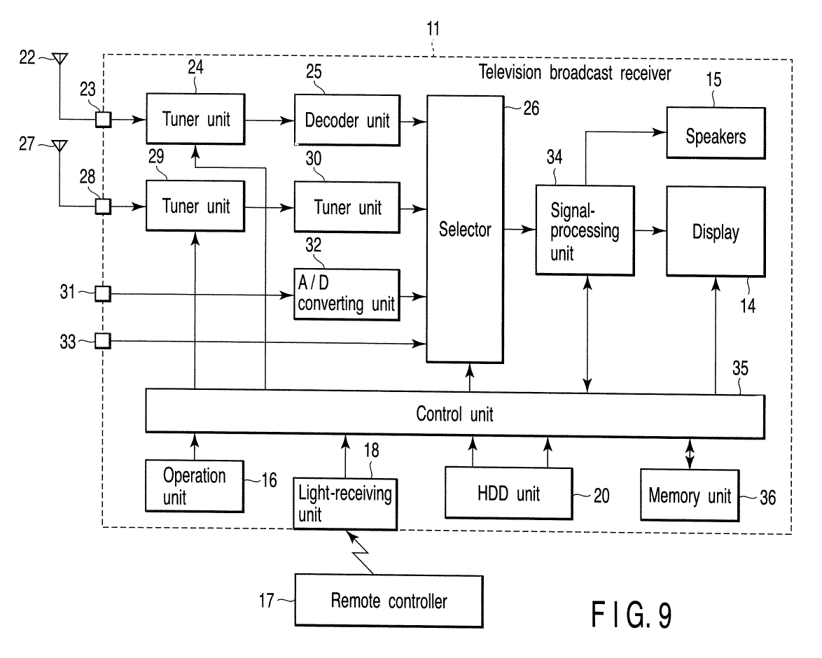

Certain embodiments of the invention are not limited to the display apparatus and method of controlling the backlight provided in the display apparatus described above. As seen from FIG. 2, the signal-processing system of the television broadcast receiver 11 is regarded as comprising two separate sections, i.e., cabinet 12 and stand 13. Nevertheless, as seen from FIG. 9, the cabinet 12 and the stand 13 can be equivalently considered to be a single unit in which the receiver 11 incorporates the HDD unit 20.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display apparatus comprising:
a receiving unit which receives a video signal;
a signal-processing unit which performs a specific process on the video signal received at the receiving unit;
a display device which displays an image represented by the video signal processed in the signal-processing unit;
a histogram-extracting unit which generates histogram distribution data for a luminance level of a video signal output from the signal-processing unit;
a first multiplier which multiplies the histogram data by multiplying values, where the higher the luminance level of each part of the histogram data is, the smaller the multiplying value applied thereto is;
a second multiplier which multiplies the histogram data by multiplying values, where the lower the luminance level of each part of the histogram data is, the smaller the multiplying value applied thereto is;
a differentiator which finds a difference between outputs of the first and second multipliers, generating control data that lowers a luminance-adjusting voltage of the display device in accordance with the magnitude ratio of the output from the first multiplier to the output of the second multiplier.

2. The display apparatus according to claim 1, wherein the display device has a backlight and the control data controls a power-supply voltage of the backlight.

3. The display apparatus according to claim 1, wherein W1>W2, where W1 is a range of luminance over which the multiplying values of the first multiplier are distributed in a descending order, and W2 is a range over which the multiplying values of the second multiplier are distributed in a descending order.

4. The display apparatus according to claim 1, wherein the multiplying values of the first multiplier are linearly distributed in a descending order, and the multiplying values of the second multiplier are linearly distributed in a descending order.

5. The display apparatus according to claim 1, wherein the multiplying values of the first multiplier are nonlinearly distributed in a descending order, the multiplying values of the second multiplier are nonlinearly distributed in a descending order, and W1>W2, where W1 is a range of luminance over which the multiplying values of the first multiplier are distributed in a descending order, and W2 is a range over which the multiplying values of the second multiplier are distributed in a descending order.

6. A method of controlling a backlight provided in a display apparatus comprising a receiving unit for receiving a video signal, a signal-processing unit for performing a specific process on the video signal received at the receiving unit, a display device for displaying an image represented by the video signal processed in the signal-processing unit, and a control unit, the method comprising:
generating histogram distribution data for a luminance level of a video signal output from the signal-processing unit;
multiplying the histogram distribution data by first multiplying values, thereby providing a first accumulated value, where the higher the luminance level of each part of the histogram data is, the smaller the multiplying value applied thereto is;
multiplying the histogram distribution data by second multiplying values distributed, each being smaller than the next one in descending order of luminance level, thereby providing a second accumulated value, where the lower the luminance level of each part of the histogram data is, the smaller the multiplying value applied thereto is;
finding a difference between the first accumulated value and the second accumulated value, thereby providing control data in accordance with a magnitude ratio of the first accumulated value to the second accumulated value, the control data being one for lowering a luminance-adjusting voltage of the display device.

7. The method according to claim 6, wherein the control data controls a power-supply voltage of the backlight provided in the display apparatus.

8. The method according to claim 6, wherein W1>W2, where W1 is a range of luminance over which the first multiplying values are distributed in a descending order, and W2 is a range over which the second multiplying values are distributed in a descending order.

9. The method according to claim 6, wherein the first multiplying values are linearly distributed in a descending order, and the second multiplying values are linearly distributed in a descending order.

10. The method according to claim 6, wherein the first multiplying values are nonlinearly distributed, each being smaller than the next one, the second multiplying values are nonlinearly distributed, each being smaller than the next one, and W1>W2, where W1 is a range of luminance over which the first multiplying values are distributed in a descending order, and W2 is a range over which the second multiplying values are distributed in a descending order.
